(19) United States
(12) Patent Application Publication
(10) Pub. No.: US 2022/0396689 A1
(43) Pub. Date: Dec. 15, 2022

(54) BLENDS OF VIRGIN HDPE AND POST CONSUMER RECYCLATE HDPE AND METHODS THEREOF

(71) Applicant: EQUISTAR CHEMICALS, LP, Houston, TX (US)

(72) Inventor: D. RYAN BREESE, LOVELAND, OH (US)

(73) Assignee: EQUISTAR CHEMICALS, LP, HOUSTON, TX (US)

(21) Appl. No.: 17/835,780

(22) Filed: Jun. 8, 2022

Related U.S. Application Data
(60) Provisional application No. 63/208,684, filed on Jun. 9, 2021.

(51) Int. Cl. C08L 23/06

(52) U.S. Cl. CPC C08L 23/06; C08L 2207/062

(57) ABSTRACT

Compounded virgin and post-consumer recyclate HDPE compositions with improved processability and mechanical properties, including processes of making, products and application in food packaging are described herein.

### PRIOR RELATED APPLICATIONS

This application claims priority to U.S. Patent Application Ser. No. 63/208,684, filed on Jun. 9, 2021, which is expressly incorporated by reference herein in its entirety.

### FEDERALLY SPONSORED RESEARCH STATEMENT

Not applicable.

### FIELD OF THE DISCLOSURE

The disclosure generally relates to blends of virgin high density polyethylene and post-consumer recyclate (“PCR”) high density polyethylene with improved processability and properties, including processes of making, and products and applications thereof.

### BACKGROUND OF THE DISCLOSURE

High density polyethylene (“HDPE”) is a thermoplastic polymer made from petroleum. The density may range from about 0.93 to about 0.97 g/cm³ and these high density polymers may have little branching of monomers and thus offer stronger intermolecular forces and tensile strength. Other properties of HDPE include its corrosion resistance, a large strength to density ratio, plus it is meltable and moldable. Furthermore, HPDE can be manufactured in such a way that it is consider food safe and can be used in food packaging and storage, although not all HPDE is food safe.

“Virgin” plastic is plastic that originates from feedstock that has never been used by a consumer—that is, non-recycled material. Because of its strength and nontoxicity, virgin HPDE is used in a variety of applications requiring high-impact resistance and melting points, including plastic bottles, milk jugs, shampoo bottles, bleach bottles, freezer and shopping bags, cutting boards, piping, etc.

Recycled HDPE may be used in applications similar to virgin HDPE, including use in bottles, piping material, outdoor plastic furniture, automobile parts, etc. However, reusable packaged products produced by recycled HDPE do not always meet the USDA requirements for direct contact with drug and/or food products made for human consumption.

In order to reduce plastic manufacturing and disposal, efforts have been ongoing to recycle plastics, but recycling processes often degrade the polymers. Thus, there have also been efforts to blend virgin and recycled plastics to provide higher quality materials. Unfortunately, blending polymers with different properties may also introduce additional variables into the finished product that may be undesirable or may produce a product of inferior quality. Thus, there is a need in the art to provide better methodology and products that combine virgin and recycled plastics.

Provided in this disclosure are methods of blending virgin and PCR HDPE to make plastics that retain or improve the properties of either virgin or post-consumer recyclate plastic for the intended end use, and may be usable in food and beverage industry.

### SUMMARY OF THE DISCLOSURE

This disclosure provides compounded HPDE polymers containing a high melt index virgin HPDE with lower melt index (MI) recycled HPDE polymers. The resulting blends have melt indexes of 1-4 g/10 min wherein melt index is measured at 190° C. under 2.16 kg force, an M_{w}/Mₙ of ≥4, and have both good processing capability, as well as good film characteristics.

### BRIEF DESCRIPTION OF THE DRAWINGS

FIG. 1. shows complex viscosity curves of a control virgin HDPE with MI of 2.0 g/10 min and a compounded blend containing 47% PCR HPDE and 53% virgin HDPE with an MI of 2.0 g/10 min.

FIG. 2. shows photographic comparisons using cross polar filters of single screw (dry blend) and twin screw (single pellet) HDPE.

FIG. 3. shows MVTR vs. overall % PCR incorporation of film structures described in Table 5 at 1.75 and 3.5 mil film thickness.

FIG. 4. shows predicted film gauge vs. overall % PCR content for polymers with an MVTR comparable to a commercial polymer (0.19 g/100 inch-day).

### DETAILED DESCRIPTION

The present disclosure relates to processing or mixing of a virgin plastic with post-consumer recyclate plastic in processing plants to provide a compounded plastic. The plastics, having been previously and independently extruded and pelletized, may be fed independently or in combination into an extruder. In the extruder, the plastics may be melted and mixed, and then extruded and pelletized for subsequent applications.

In one embodiment, the plastics (virgin and PCR HDPEs) may be mixed in an extruder using a single screw extruder. Testing the single screw blending method, indicated that it may be less preferred where high quality films are needed. Compositions made in single-screw extrusion may have significant gels in the resulting films. This may be acceptable for certain applications, but for high quality films, a higher shear compounding method is preferred.

In an another embodiment, a co-rotating twin screw extruder or any other high shear method may be used to mix or otherwise compound the virgin and recycled polymers. In one embodiment of a twin-screw compounding extruder, two intermeshing, co-rotating screws mounted on splined shafts in a closed barrel are used. The compounded plastics of the present disclosure may be more homogeneously mixed in a twin screw extruder as compared to a single screw extruder, but any sufficiently high shear method could be used, such as continuous mixers, Banbury mixers, and the like. In one embodiment, the virgin HDPE and the PCR HDPE are melt compounded with a specific mechanical energy greater than about 0.15 kW/kg/hr; alternatively from 0.15 kW/kg/hr to 0.5 kW/kg/hr; and alternatively from 0.20 kW/kg/hr to 0.4 kW/kg/hr.

Further details on co-rotating twin-screw extruders for compounding HDPE may be found in James L. White and Eung K. Kim in Twin Screw Extrusion: Technology and Principles (2^{nd} Ed.) Carl Hanser Verlag, Munich 2010; Klemens Kohlgruber and Werner Wiedmann, in Co-rotating Twin-Screw Extruders: Fundamentals, Technology, and Applications, Hanser, Munich 2008; Chan I. Chung in Extrusion of Polymers: Theory and Practice, Carl Hanser Verlag, Munich 2000; and Paul Anderson in Mixing and Compounding of Polymers (2nd Ed), Ed. Manas-Zloczower, Tadmore 2009, Chapter 25, p. 947, the contents of which are each hereby incorporated by reference in their entireties for all purposes.

For preparation of plastic films for the food packaging industry, blown film extrusion or blown film coextrusion or hot blown processes, and the like may be used. In one embodiment of a blown bubble process, plastic in the form of small beads or pellets may be fed through a feed coat to a barrel that contains a rotating screw attached that forces the plastic pellets forward to a heated barrel. At a desired extrusion temperature set by the process and the type of desired plastic output, molten plastic may be formed that leaves the circular extrusion die as a film. Air pressure may be used to further expand the film in the form of a bubble. After the expansion to the desired dimensions, the film may be cooled to solidify it. Films may be defined as less than 0.254 mm (10 mils) in thickness, although blown films can be produced as high as 0.5 mm (20 mils).

During any film extrusion process, the desired film may have a constant gauge. Formation of a stable bubble in a blown bubble process may be therefore important to make good films. However, barrier performance is often another important factor for choosing material for packaging industry to extend the shelf-life of foods. It may be defined as the material's ability to prevent transmission of moisture or oxygen through the combined coating and substrate. Lower moisture vapor transmission rates (“MVTR”) of a plastic provides for a better barrier and thus a better plastic material for food packaging.

Melt Index (“MI”) is a measure of the ease of flow of the melt of a plastic. Applicants presently believe that a material with high melt index typically has better barrier properties, but poor bubble properties due to lower viscosity. In the blown bubble film process, the bubble stability may decrease with increasing MI, with an example of an upper limit for MI being about 2.0 g/10 min. Without being bound by this theory, the Applicants presently believe that there is a possibility that decreasing MI improves bubble stability, but increases MVTR and melt viscosity, which may compromise barrier performance and extruder output and limit the MI to about 0.8.

Another parameter used in developing the blends of this disclosure is molecular weight distribution (“MWD”). All synthetic polymers are polydisperse in that they contain polymer chains of unequal length, and so the molecular weight is not a single value—the polymer exists as a distribution of chain lengths and molecular weights. By targeting a somewhat broader distribution of chain lengths, the compounded polymers have both good performance characteristics (as an example, acceptable moisture barrier properties for the film applications) and improved processing characteristics (for example, bubble stability and extruder output in film applications).

In one embodiment, the compounded polyethylene composition of the present disclosure has a MWD as assessed by M_{w}/Mₙ of at least 4. In another embodiment, the compounded polyethylene composition has an M_{w}/Mₙ of at least 6, alternatively at least 7, alternatively at least 8, alternatively from about 4 to about 10, alternatively from about 5 to about 7.

The compounded polymers of the disclosure were tested and found a satisfactory bubble stability and MVTR at MI of about 2 g/10 min, about 20 to 40% PCR and an M_{w}/Mₙ of at least 4 or 4-10, even when the films are thinner than currently used films.

In another embodiment, the compounded polymers has a MVTR less than 0.20 g/100 inch²/day when measured at 1.5 mil, 37.8° C. and 90% humidity; alternatively the MVTR is less than 0.12 g/100 inch²/day or less than 0.08 g/100 inch²/day.

In more detail, a virgin HDPE with a high melt index is combined with a suitable post-consumer recyclate HDPE with a lower melt index to produce a blend with intermediate MI, an M_{w}/Mₙ greater than about 4, and improved processability. This is achieved by high shear melt mixing of the virgin and PCR HDPE in, for example, a twin-screw compounding extruder, also called “single pellet” solution. The blend can be used in multi-layer film structures to balance overall PCR content in the plastic, moisture barrier, material cost and film gauge.

The virgin HDPE of the present disclosure may have a melt index of greater than 2 g/10 min. In an alternative embodiment, it has a MI of 2-18, or more preferably 2-10 or 2-8 g/10 min. By contrast, the recycled HPDE will have a lower MI, for example, 0.40-0.9, or 0.5-0.85 or about 0.70-0.8. The compounded plastic will typically have an intermediate level of MI, depending on the ratios of the two plastics used. In general, the ratio of the two components is selected to target a final blend MI of from 0.8 to 4, alternatively from 1 to 3, alternatively from 1.5 to 2.5 or about 2.

The virgin and/or recycled HDPE of the present disclosure may have an M_{w}/Mₙ greater than about 4. In an alternative embodiment, the virgin and/or recycled HDPE of the present disclosure may have an M_{w}/Mₙ greater than 5, 6, or 8, and alternatively greater than 10. The compounded material may have a similar distribution as the starting materials, or an intermediate value if plastics with differing M_{w}/Mₙ are used. However, in general a larger M_{w}/Mₙ, in the final product is preferred, e.g., 4, 5, 6, 8, 10, and the like, as it improves the processability. Ranges include M_{w}/Mₙ of 4-10, 4-8, 4-6, 5-8 or 5-6.

The virgin and/or recycled HDPE starting materials may have a density above 0.94 g/cm³. In an alternative embodiment the virgin and/or recycled HDPE of the present disclosure may have a density ranging from about 0.954 to 0.965 g/cm³. In an alternative embodiment the virgin and/or recycled HDPE of the present disclosure may have a density ranging from about 0.950 to 0.960 g/cm³. The compounded HPDE may be similar, or intermediate the two if the starting materials have different densities.

Suitable blends of high MI virgin polymers and low MI PCR polymers range in viscosity at a shear rate of 0.025 radians/second from 8.0×10⁴ to 1.2×10⁵ poise, alternatively from 8.4×10⁴ to 1.0×10⁵ poise, alternatively from 8.9×10⁴ to 9.4×10⁴ poise. Suitable blends of high MI virgin polymers and low MI PCR range in viscosity at a shear rate of 0.025 radians/second from 14% to 68% higher than a 100% virgin polymer with a MI=2, alternatively from 21% to 48% higher than a 100% virgin polymer with a MI=2, alternatively from 28% to 34% higher than a 100% virgin polymer with a MI=2.

Suitable blends of high MI virgin polymers and low MI PCR range in viscosity at a shear rate of 100 radians/second from 8.8×10³ to 5.5×10³ poise, alternatively from 8.4×10³ to 6.7×10³ poise, alternatively from 8.0×10³ to 7.6×10³ poise. Suitable blends of high MI virgin polymers and low MI PCR range in viscosity at a shear rate of 100 radians/second from 5% to 41% lower than a 100% virgin polymer with a MI=2, alternatively from 10% to 28% lower than a 100% virgin polymer with a MI=2, alternatively from 14% to 19% lower than a 100% virgin polymer with a MI=2.

In one embodiment, the compounded polymers may have at least 15% recycled HPDE, preferably at least 20, 30, 40, 50 or about 60% recycled HDPE. Higher amounts are possible, but the cost of PCR HPDE is currently about 10% higher than virgin HPDE and thus 20-45%, or 25-40% may be preferred. However, most commercial film lines are multi-layer coextrusions with 3 to 11 layers, and in a multilayer film, targeting a higher PCR concentration may be desirable, as some layers (such as sealant layers, tie layers, high barrier layers, etc.) may need to remain 100% virgin to maintain overall multilayer film performance. Thus, multilayer film structures can be created to balance the overall film barrier performance, total PCR content, the use of lower cost materials and film gauge (for cost saving and additional sustainability impact).

The virgin and recycled HDPE blend can therefore be used in multi-layer film structures to balance overall PCR content in the plastic, moisture barrier, material cost and film gauge. Compounding virgin and PCR HDPE of different melt index can provide a plastic film that can be processed at higher extruder output as compared to virgin HDPE.

The compounded plastic and sheets or films made therefrom can be used in any product typically made with HDPE, include for example, plastic bottles, plastic bags, food safe containers, food safe and other films, cutting boards and other food processing equipment, water tanks, piping and fittings, toys, playground equipment, chemical containers, furniture, signage and fixtures, kick plates, fuel tanks, lockers, packaging, chute linings, vehicle interiors, and the like.

The present disclosure includes any one or more of the following embodiments, in any combination(s) thereof:

A compounded polymer having a) 50-80 weight % of a virgin high density polyethylene (virgin HDPE) having a melt index of about 2.0-18.0 g/10 min; b) 20-50 weight % of a post-consumer recyclate high density polyethylene (PCR HDPE) having a melt index of about 0.3 to about 1 g/10 min; c) wherein said compounded polymer has a melt index of about 1-4 g/10 min and a density of about 0.950-0.960 g/cm³ and a weight averaged molecular weight/number averaged molecular weight (M_{w}/Mₙ) of 4; and d) wherein melt index is measured at 190° C. under 2.16 kg force.

Any compounded polymer herein described, wherein the compounded polymer is mixed using specific mechanical energy greater than 0.15 kW/kg/hr at a temperature over 125° C., or 0.15-0.5 kW/kg/hr; or 0.20-0.4 kW/kg/hr. Preferably, the compounded polymer is mixed using a twin-screw compounding extruder at a temperature of 125-299° C., or 150-220° C.

Any compounded polymer herein described, wherein the virgin HDPE has a melt index of about 6-18 or 7-10 g/10 min., and the PCR HDPE has a melt index of about 0.5 to 0.85 or about 0.8 g/10 min.

Any compounded polymer herein described, wherein the compounded polymer has a M_{w}/Mₙ≥5.

Any compounded polymer herein described, wherein the virgin HDPE and the PCR HPDE each have a density of 0.930-0.970 g/cm³ and the compounded polymer has a density of about 0.96 g/cm³.

Any compounded polymer herein described, wherein the ratio of virgin HPDE to PCR HPDE is about 20/80, 30/70, 40/60, 47/53, 50/50 or 60/40.

Any compounded polymer herein described, wherein the virgin HPDE and the PCR HPDE are food safe and/or the resulting compounded polymer is food safe.

Any compounded polymer herein described, said compounded polymer comprising 50-80 weight % of a virgin HDPE having a melt index of about 8 g/10 min; 20-50 weight % of a PCR HDPE having a melt index of about 0.5-0.85 g/10 min; and wherein said compounded polymer has a melt index of about 2 g/10 min and a density of about 0.950-0.960 g/cm³ and an M_{w}/Mₙ≥5.

Any compounded polymer herein described, said compounded polymer comprising: 45-55 weight % of a virgin HDPE having a melt index of about 8 g/10 min; 45-55 weight % of a PCR HDPE having a melt index of about 0.5-0.9 or about 0.8 g/10 min; and wherein said compounded polymer is food safe and has an melt index of about 2 and a density of about 0.950-0.960 g/cm³ and an M_{w}/Mₙ≥5.

A polymeric film made from any compounded polymer herein described. Preferably, the film has 90% fewer gels than a similar polymer compounded with a single screw extruder. Preferably the film has a defect count less than 133 defects per meter² for a defect size between 500 mm and 7500 mm, or a defect count less than 15 defects per meter² for a defect size between 750 mm and 1000 mm, or a defect count less than 1.5 defects per meter² for a defect size between 1000 mm and 1250 mm, or a defect count less than 1.5 defects per meter² for a defect size of at least 1250 mm.

A multilayer film comprising one or more layers of any compounded polymer herein described and one or more layers of virgin polymer. Preferably, the multilayer film has a moisture vapor transmission rate (MVTR) of less than 0.28 g/100 inch²/day when measured at 1.5 mil, 37.8° C. and 90% humidity, or the MVTR is less than 0.12 g/100 inch²/day, or the MVTR is less than 0.08 g/100 inch²/day.

As used herein, the term ‘virgin’ refers to an unused material, as provided by the manufacturer.

As used herein, ‘PCR’ or ‘post-consumer recycled’ plastic refers to plastic that has been molded into a product, used by the consumer and then recycled.

As used herein, the term ‘compounded plastic’ or ‘compounded polymer’ or ‘blended polymer’ refers to a homogeneous blend containing virgin and PCR HDPE, and possibly other minor additives.

As used herein, the percentage of virgin or recycled HPDE is a weight percentage of the HPDE polymers, and excludes any minor additives such as colorants, lubricants, and the like.

As used herein, the ‘melt index’ (MI′) or ‘melt flow index’ (‘MFI’) refers to the measurement of the rate of extrusion of molten resins through a standard die (2.095×8 mm) according to ASTM D1238-20 (procedure B) at 190° C. and under 2.16 kg force. It is defined as the weight of polymer in grams flowing in 10 min through a standardized capillary under a standard load at a given temperature. In general, plastic with a high MI indicates a lower material viscosity, and MI is compared to compare flow characteristics of two plastics.

As used herein, ‘moisture vapor transmission rate’ or ‘MVTR’, also known as ‘water vapor transmission rate’ or ‘WVTR’, is determined by ASTM F1249-20. At a selected temperature and humidity a barrier film is sealed between a wet chamber and dry chamber. Typically in the USA, standard temperature of 37.8° C. and relative humidity of 90% is used for food industry for films up to 3 mm in thickness. A pressure modulated sensor measures moisture transmitted through the material tested. The amount of water vapor that permeates a substance over a given time is measured providing a measurement for the permeability of vapor barriers. It is typically measured in g/day for a 100 square inch portion of film at a stated thickness. Lower MVTR values of a plastic provides for a better barrier and thus a good plastic material for food packaging and other products subject to vapor damage or dessication.

As used herein, ‘normalized’ MVTR refers to the moisture-vapor transmission rate that is normalized for film thickness at 1.5 mil.

As used herein, the ‘molecular weight distribution’ or ‘MWD’ as well as the number averaged molecular weight (“Mₙ”) and weight averaged molecular weight (“M_{w}”), are determined using a high temperature Polymer Char gel permeation chromatography (“GPC”), also referred to as size exclusion chromatography (“SEC”).

In more detail, GPC was equipped with a filter-based infrared detector, IRS, a four-capillary differential bridge viscometer, and a Wyatt 18-angle light scattering detector. M_{w}, Mₙ, MWD, and short chain branching (SCB) profiles were reported using the IR detector, whereas long chain branch index, g′, was determined using the combination of viscometer and IR detector at 145° C. Three Agilent PLgel Olexis GPC columns were used at 145° C. for the polymer fractionation based on the hydrodynamic size in 1,2,4-trichlorobenzene (TCB) with 300 ppm antioxidant butylated hydroxytoluene (BHT) as the mobile phase. 16 mg polymer was weighted in a 10 mL vial and sealed for the GPC measurement. The dissolution process was obtained automatically (in 8 ml TCB) at 160° C. for a period of 1 hour with continuous shaking in an Agilent autosampler. 20 μL Heptane was also injected in the vial during the dissolution process as the flow marker. After the dissolution process, 200 μL, solution was injected in the GPC column. The GPC columns were calibrated based on twelve monodispersed polystyrene (PS) standards ranging from 578 g/mole to 3,510,000 g/mole. The comonomer compositions (or SCB profiles) were reported based on different calibration profiles obtained using a series of relatively narrow polyethylene (polyethylene with 1-hexene and 1-octene comonomer were provided by Polymer Char, and polyethylene with 1-butene were synthesized internally) with known values of CH₃/1000 total carbon, determined by an established solution NMR technique.

GPC one software was used to analyze the data. The long chain branch index, g′, was determined as follows:

g′=[η]/[η]ₗᵢₙ

where, [η] is the average intrinsic viscosity of the polymer derived by summation of the slices over the GPC profiles as follows:

$$[ η ] = \frac{\sum {{c}_{i} [ η ]}_{i}}{\sum {c}_{i}}$$

where cᵢ is the concentration of a particular slice obtained from IR detector, and [η]ᵢ is the intrinsic viscosity of the slice measured from the viscometer detector. [η]ₗᵢₙ is obtained from the IR detector using Mark-Houwink equation [η]ₗᵢₙ=ΣK Mᵢ^{α} for a linear high density polyethylene, where Mᵢ is the viscosity-average molecular weight for a reference linear polyethylene, K and α are Mark-Houwink constants for a linear polymer, which are K=0.000374, α=0.7265 for a linear polyethylene and K=0.00041, α=0.6570 for a linear polypropylene.

Plastic film thickness is commonly measured using a micrometer ASTM-D6988 or ASTM-D8136. Mil is a common unit of thickness measurement for plastic films. Thickness is also commonly represented in gauge. A simple conversion is 1 mil=100 gauge=25.4 micron.

As used herein, “OCS” or “optical control system” is a method of determining film quality whereby a high-resolution camera takes pictures of the film and identifies and quantitates gels or imperfections. The software is configured to classify the gels and report out a composite gel counts. U.S. Pat. No. 7,393,916 provides exemplary details of OCS and the composite gel count.

As used herein, a ‘gel’ refers to imperfections in a polymeric film. Gels are localized imperfections that are visually distinct from the surrounding film, and can be caused by uncompounded polymers, unreacted catalysts, etc.

“Downgauge” or “downgauging a plastic film” as used herein means to make a plastic film that is thinner. This is done for a number of reasons, including sustainability, reducing material cost, or based on application needs.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed, and excludes all additional elements. The phrase “consisting essentially of” excludes additional material elements, but allows the inclusions of non-material elements that do not substantially change the nature of the disclosure, such as instructions for use, colorants, lubricants, and the like. Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

| ABBREVIATION | TERM |
|---|---|
| ASTM | American Society for Testing and Materials |
| EVA | ethylene vinyl acetate |
| GPC | Gel permeation chromatography |
| HDPE | High Density Polyethylene |
| MD | Machine direction |
| Ml | Melt Index, also MFI or melt flow index |
| MVTR | Moisture-vapor transmission rate |
| M_{w}/Mₙ | M_{w}/Mₙ is called the molar-mass dispersity index (often called polydispersity |
| | index (PDI)). Mₙ is the number averaged MW, and M_{w} is the weight averaged |
| | MW. The midpoint of the distribution in terms of the number of molecules is |
| | M_{w}. If all polymer chains are exactly the same, then the number-average |
| | and weight average molecular weights are exactly the same and the PDI is |
| | 1. The larger the molar-mass dispersity index, the wider is the molecular |
| | weight distribution. |
| MWD | Molecular weight distribution, see also M_{w}/Mₙ |
| NMR | Nuclear magnetic resonance |
| OCS | Optical Control System |
| PCR | Post consumer recyclate |
| PDI | polydispersity index, see also MWD and M_{w}/Mₙ |
| PS | Polystyrene |
| SCB | short chain branching |
| TD | Transverse direction |

The examples herein are intended to be illustrative only, and not unduly limit the scope of the appended claims. Although the present disclosure and its advantages have been described in detail, it should be understood that various changes, substitutions and alterations can be made herein without departing from the scope of the disclosure as defined in the claims.

### Blending of Virgin and Recycled HDPE

A virgin homopolymer HDPE having a higher MI (such as without limitation injection molding HDPE grade M6080, MI of 8.0 g/10 min, density=0.960 g/cm3, melting temperature 132.7° C., and available from LyondellBasell Industries, Houston, Tex.) was compounded with a lower MI PCR grade polymer with MI of 0.5-0.85 g/10 min (such as the PCR HDPE EcoPrime C+ available from Envision Plastics, Reidsville, N.C.), using the high melt twin-screw compounding extruder single pellet method, followed by characterization using OCS.

The properties of the virgin plastic (M6080) are shown in Table 1.

TABLE 1
LYONDELLBASELL ALATHON ® M6080 HIGH DENSITY
POLYETHYLENE, INJECTION MOLDING GRADE
Physical Properties
Bulk Density 0.593-0.625 g/cm³
Density 0.960 g/cm³
Melt Flow Index 7.9 g/10 min @Load 2.16 kg, Temperature 190° C.
Spiral Flow 21.8 cm
Mechanical Properties
Hardness, Shore D 70
Tensile Strength at Break 15.9 MPa
Tensile Strength, Yield 29.3 MPa
Elongation at Break 380%
Tensile Modulus 0.8453 GPa
Tensile Modulus 1.009 GPa
Flexural Modulus 1.071 GPa
Flexural Modulus 1.311 GPa
Flexural Modulus 1.414 GPa
Izod Impact, Notched 0.747 J/cm
Izod Impact, Notched NB @Temperature-18.0° C.
Thermal Properties
Melting Point 132.7° C.
Crystallization Temperature 115.9° C.
Deflection Temperature at 0.46 MPa (66 psi) 80.0° C.
Brittleness Temperature <= −76.0° C.
Processing Properties
Rear Barrel Temperature 232° C.
Middle Barrel Temperature 243° C.
Front Barrel Temperature 246° C.
Nozzle Temperature 246° C.

The recycled HPDE EcoPrime C+ by Envision Plastics was largely made from recycled milk jugs per US2013015604. The bottles were ground and sorted into flakes, which were cleaned in a wash line. The plastic was melted and formed into pellets, and then put through a proprietary process using heat and air to purify the plastic without the use of chemicals. As a result, even though recycled, the FDA allows its use at levels up to 100% in HDPE packaging for fatty foods and spirits.

Certain properties of the recycled plastic are shown in Table 2.

TABLE 2

| ENVISION PLASTICS ECOPRIME C+ | ASTM |
|---|---|
| Physical Properties | |
| Density 0.958-0.965 g/cm³ | D792 |
| Melt Index 0.5-0.85 g/10 min at 2.16 kg, 190° C. | D1238 |
| Moisture <0.050% | D6980 |
| Mechanical Properties | |
| Flex modulus 111,500 psi | D790 |
| Elongation at Break 197% | D638 |
| Impact resistance 4.5 ft-lb/in | D256 |
| Mold shrinkage Length 2.98% | |
| Mold shrinkage Width 2.6% | |

The method used for blending the virgin and recycled plastic was carried out by a continuous process by introducing the plastic pellets simultaneously into a twin-screw extruder. Typically for HDPEs, compounding is performed at barrel set temperature range of 150-220° C. and varying screw speeds of the twin-screw extruder. Typical extruder temperature profiles are about 180/200/210/210/210° C. with residence times ranging from 5 to 60 seconds.

In more detail, the proof of concept work was done with extruder barrel temperature that ranged from 150° C. at the feed throat and 220° C. at the die, although ranges of 125-299° C. are acceptable, and can vary even further depending on the starting materials. The extruder output was set to 100 lbs/hr, but can range from about 50-150 lbs/hr. The specific mechanical energy was 0.25 kW/Kg/hr, but can include ranges of about 0.15-0.5 kW/Kg/hr. The extruder screw speed used was 300 rpm, but ranges of about 200-400 or even wider are acceptable, providing that sufficient mixing is achieved.

The resulting compounded plastic—M6020SBRX01—contained 47% recycled HPDE and 53% virgin HDPE. Compounded M6020SBRX01 could be processed at higher extruder outputs compared with virgin HDPE of similar MI, and higher viscosity at low shear rates in the extruder, thus displaying better bubble stability.

Certain properties of the blend M6020BRX01 are found in Table 3.

TABLE 3
COMPOUNDED VIRGIN HPDE and PCR HPDE (M6020BRX01)

| Melt Index (190° C., 2.16 kg) | 2 g/10 min | | ASTM D1238 |
|---|---|---|---|
| Density (23° C.) | 0.959 | g/cm³ | ASTM D1505 |
| Tensile strength at break MD | 6100 | psi | ASTM D882 |
| Tensile strength at break TD | 3400 | psi | ASTM D882 |
| Tensile strength at yield MD | 3700 | psi | ASTM D882 |
| Tensile strength at yield TD | 4600 | psi | ASTM D882 |
| Secant modulus MD | 740% | | ASTM D882 |
| Secant modulus TD | 520% | | ASTM D882 |
| Elmendorf tear strength MB | 37 | g | ASTM D1922 |
| Elmendorf tear strength TD | 80 | g | ASTM D1922 |

### Behaviour at Varying Shear Rates

Viscosity Flow Curves—also known as a rheogram—are graphical representations of how a flowing material (fluid) behaves when it is subjected to increasing or decreasing shear rates. Complex viscosity (q) is the frequency-dependent viscosity function determined for a non-Newtonian viscoelastic fluid by subjecting it to oscillatory shear stress. A rheometer under a strain of 20% at 190° C. was used to sweep frequencies from the greatest frequency (400 rad/s), to the lowest (0.025 rad/s) for each of the test polymers, and data recorded.

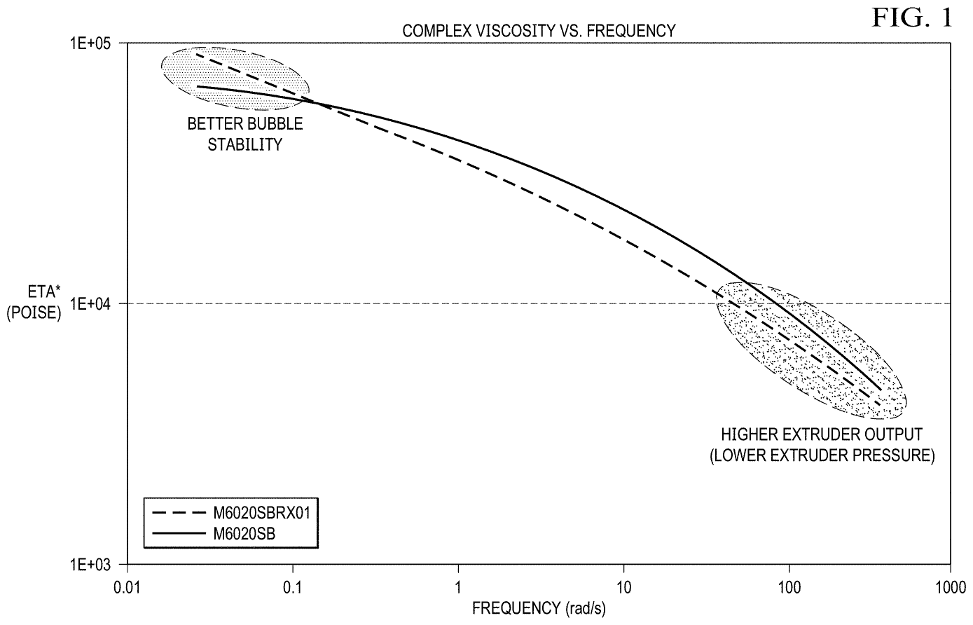

FIG. 1 is the complex viscosity curve of virgin HDPE (M6020SB) with a MI of 2.0 g/10 min compared with the viscosity curve of a compounded HDPE (M6020SBRX01) containing 47% PCR HPDE and 53% virgin HDPE (M6080) and an MI of 2.0 g/10 min. The M6020SB polymer has comparable MI (both about 2) to the compounded M6020SBRX01, and thus was selected as a better comparator than the starting material M6080.

At higher shear rates (radians per second), a 26% reduction in extruder head pressure was observed for the compounded HDPE. This allows for better filtration and thus higher output of the plastic film produced. In addition, the M6020SBRX01 showed better bubble stability at lower shear rate, because of higher viscosity, thus improving our ability to blow films from the new compounded plastic.

### Comparison of Blending Techniques

A target of 2.0 mil thick plastic HDPE film was prepared using the high shear melt mixing twin-screw compounding extruder method described above and compared against a similar film made from the same ingredients prepared with a single low shear screw method without screens to size limit the material. The melt temperature in the single screw extruder was set to 169° C., the rpm was 50 and the output was 10 lbs/hr.

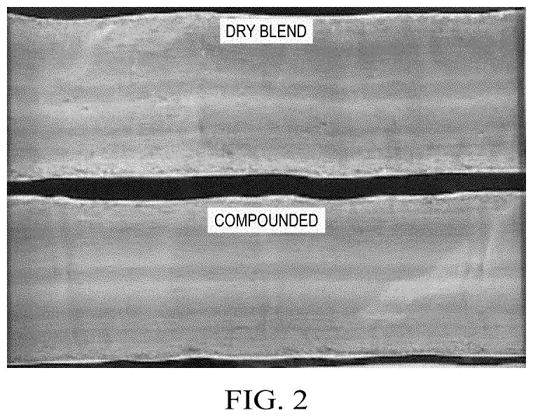

The data on film composition and characteristics was obtained using OCS camera attached to the extruder system and are presented in Table 4 and a photographic example is shown in FIG. 2.

TABLE 4
Defect Distribution comparison for Single Pellet and Dry Blend
polymer blends.

| Defect Distribution Size avg/[m²] | Single Pellet | Dry Blend |
|---|---|---|
| Total Defect (ppm) | 289 | 2562 |
| 350 micron | 2282 | 10688 |
| 500 micron | 732 | 5676 |
| 750 micron | 134 | 2221 |
| 1000 micron | 13 | 420 |
| 1250 micron | 1 | 109 |
| 1500 micron | 0 | 37 |
| 1750 micron | 0 | 15 |
| 2000 micron | 0 | 6 |
| >2000 micron | 0 | 5 |

As seen from the table above and FIG. 2, the defects in polymer film produced by single pellet solution as detected by OCS are significantly lower than film produced by dry blend. A total overall defect of about 289 ppm is observed in film prepared by the high shear compounding, whereas overall defects of 2562 was seen in films produced by dry blend.

Using the high shear melt mixing using twin-screw compounding to blend HDPE, 90% overall reduction in gel level was observed with the reduction or elimination of the largest gels (1500 microns and above). Ideally, the method produces films with 85-95% fewer gels, and total defect levels of between 250-300 defects, 350 micron defect levels of 2000-2500, 500 micron defect levels of 650-750, 750 micron defect levels of 100-150, at least 1000 micron defect levels of fewer than 20, or fewer than 10, or fewer than 5. Indeed, no defects larger than 1500 microns were observed, which contrasts with the film made by lower shear. The blending using twin-screw extruder also provided more consistent barrier properties with uniform heat seal strength and also improved aesthetics and consumer acceptance. Thus, high shear compounding is preferred, such as can be obtained by the twin-screw extruder or other high shear methods, such as continuous mixers, Banbury mixers, and the like.

### Films Made with Virgin/Recycled HPDE

Multilayer films were created to balance the overall film barrier performance, PCR content, use of lower cost materials and film gauge—for cost saving and additional sustainability impact.

Three 7-layer films were made with varying overall PCR content of 20, 30 or 40% and the rest being virgin HPDE, except for sealant layer 7, which was an EVA layer. Layers were composed of compounded blend M6020SBRX01 with between zero and two layers of virgin HDPE M6020SB to vary the overall PCR content. The sealant layer (7) in the film was comprised of virgin EVA (example, UE637000 by LyondellBasell, containing 9% EVA), but this is exemplary only and other sealant layers could be used.

Table 5 details the composition of the three 7-layer films and the amounts of compounded blend M6020SBRX01 and virgin M6020SB used for each layer. The layer % indicates how much of the total film thickness that layer contributes.

TABLE 5
7-Layer blown film structure of various overall PCR composition

| | | 20% PCR | 30% PCR | 40% PCR |
|---|---|---|---|---|
| Layer | Layer % | Polymer Grade | Polymer Grade | Polymer Grade |
| 1 | 20% | M6020SBRX01 | M6020SBRX01 | M6020SBRX01 |
| 2 | 20% | M6020SB | M6020SB | M6020SBRX01 |
| 3 | 7% | M6020SBRX01 | M6020SBRX01 | M6020SBRX01 |
| 4 | 6% | M6020SBRX01 | M6020SBRX01 | M6020SBRX01 |
| 5 | 7% | M6020SBRX01 | M6020SBRX01 | M6020SBRX01 |
| 6 | 25% | M6020SB | M6020SBRX01 | M6020SBRX01 |
| 7 | 15% | UE63700 | UE63700 | UE63700 |

Virgin M6020SB used as virgin layer in-between compounded blend layers and is a medium molecular weight high density polyethylene homopolymer for use in blown film applications with an MI of 2.0 g/10 min, and certain properties of which are shown in Table 6.

TABLE 6
LyondellBasell Industries Alathon ® M6020SB High Density (MMW) Polyethylene

| Physical | Nominal Value | Test Method |
|---|---|---|
| Density² | 0.959 g/cm³ | ASTM D1505 |
| Melt Mass-Flow Rate | 2.0 g/10 min | ASTM D1238 |
| (MFR) (190° C./2.16 kg) | | |
| Films | Nominal Value | Test Method |
| Secant Modulus MD | 146000 Psi | ASTM D882 |
| Secant Modulus TD | 191000 Psi | ASTM D882 |
| Tensile Strength at yield MD | 4150 Psi | ASTM D882 |
| Tensile Strength at yield TD | 5130 Psi | ASTM D882 |
| Tensile Strength at Break MD | 6690 Psi | ASTM D882 |
| Tensile Strength at Break TD | 3760 Psi | ASTM D882 |
| Tensile Elongation at Break MD | 870% | ASTM D882 |
| Tensile Elongation at Break TD | 650% | ASTM D882 |
| Elmendorf Tear Strength MD | 32 g | ASTM D1922 |
| Elmendorf Tear Strength TD | 90 g | ASTM D1922 |

### MVTR of Virgin/Recycled HPDE Films

MVTR (expressed in g/100 inch-day) for the three compounded films (20, 30 and 40% overall recycled material in the multilayer film) produced according to Table 5 was measured at two thicknesses of 1.75 mil and 3.50 mil. This was compared with a cereal liner having a film thickness of 1.9 mil and MVTR of 0.19 g/100 inch-day. The cereal liner, typically made of virgin HDPE, is a multilayer film with a thickness of 1.9 mils that also incorporates lower cost/lower barrier resins in some layers.

Barrier data was normalized per mil of HDPE in the film structure. The EVA layer has very low moisture barrier properties, which is why the barrier layers are needed. The EVA layer is a sealant layer and was held constant across the samples.

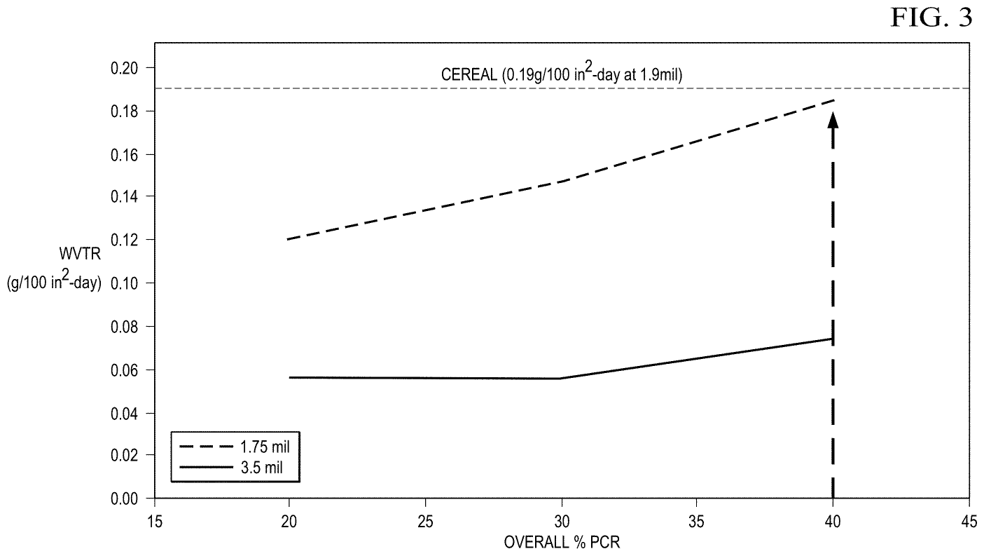

The comparison presented in FIG. 3 shows that by incorporating compounded HDPE with 20-40% PCR content in the overall HDPE film, the current market barrier performance (target of 0.19 indicated by top dotted line) can be met, even at the reduced 1.75 mil thickness. Thus, the use of 20-40% recycled material compounded as described herein can provide food safe plastics at lower cost and with lower environmental impact.

### Film Gauge of Virgin/Recycled HPDE

Multilayer films made as described in Table 5 can be downgauged (made thinner) and yet retain acceptable barrier properties. Downgauging is performed during the extruder process by drawing the molten polymer down to thinner gauges.

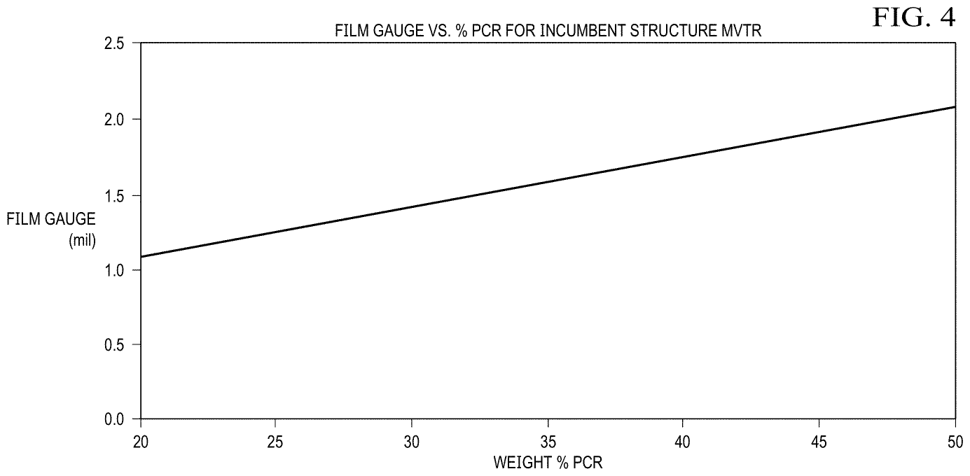

FIG. 4 shows the predicted result of film thickness achieved by downgauging and overall PCR composition in the polymer film. As seen in the figure, with an overall required PCR composition of 25%, a film of thickness of 1.25 mil can be achieved that has comparable MVTR to current commercial film structure, such as the 1.9 mil cereal liner. By incorporating PCR, a 34% reduction in overall film thickness can be achieved, yet retain the desired barrier properties. Thus, the ability to downgauge films containing PCR is an advantage over commercially available virgin plastics, allowing thinner films with the same moisture barrier properties, thus saving on materials and positively impacting sustainability.

The foregoing disclosure describes preferred embodiments of the present disclosure. In view of this description, various changes and modifications may be suggested to one skilled in the art. For example, additional additives may be added to the above composition to achieve additional desired characteristics for a food grade composition. Accordingly, such changes and modifications should be considered within the scope of the present disclosure.

The following references are each incorporated by reference in their entireties for all purposes. The ASTM standards cited herein are used to measure the characteristics of the claimed polymers.

ASTM D256-10 Standard Test Methods For Determining The Izod Pendulum Impact Resistance Of Plastics.

ASTM D638-14 Standard Test Method For Tensile Properties Of Plastics.

ASTM D790-17 Standard Test Methods For Flexural Properties Of Unreinforced And Reinforced Plastics And Electrical Insulating Materials.

ASTM D792-20 Standard Test Methods For Density And Specific Gravity (Relative Density) Of Plastics By Displacement.

ASTM D1238-20 Standard test method for melt flow rates of thermoplastics by extrusion plastometer.

ASTM F1249-20 Standard test method for water vapor transmission rate through plastic film and sheeting using a modulated infrared sensor.

ASTM D6980-17 Standard Test Method For Determination Of Moisture In Plastics By Loss In Weight.

ASTM D6988-21 Standard guide for determination of thickness of plastic film test specimens.

ASTM D7310-21 Standard practice for defect detection and rating of plastic films using optical sensors.

ASTM D8136 Standard test method for determining plastic film thickness and thickness variability using a non-toxic contact capacitance thickness gauge.

US2013015604 Process of Producing PCR Pellets.

U.S. Pat. No. 7,393,916 Method of reducing gels in polyolefins.

U.S. Ser. No. 10/124,527 Extrusion process for polyethylene polymers.

U.S. Ser. No. 10/138,310 Preparation of LLDPE resins and films having low gels.

Cutzwiler, G. W., et al., ‘Mixed post-consumer recycled polyolefins as a property tuning material for virgin polypropylene.’ J. Cleaner Production (2019) 239:117978. doi.org/10.1016/j.jclepro.2019.117978.

Todd, W. ‘Variables that affect/control high-density polyethylene film oxygen-moisture barrier.’ Journal of Plastic Film & Sheeting (2003) 19(3): 209-220.

McKeen, L. W., Permeability properties of plastics and elastomers, Fourth Ed. (2017).

Albareeki, M. M.; Discoll, S. B.; Barry, C. F. ‘Compounding of polyethylene composites using high speed twin and quad screw extruders.’ AIP Conf. Proc. 2139 (2019), 020006. doi.org/10.1063/1.5121653.

What is claimed is:

1. A compounded polymer, said compounded polymer comprising:
a) 50-80 weight % of a virgin high density polyethylene (virgin HDPE) having a melt index of about 2.0-18.0 g/10 min;
b) 20-50 weight % of a post-consumer recyclate high density polyethylene (PCR HDPE) having a melt index of about 0.3 to about 1 g/10 min;
c) wherein said compounded polymer has a melt index of about 1-4 g/10 min and a density of about 0.950-0.960 g/cm³ and an weight averaged molecular weight/number averaged molecular weight (M_{w}/Mₙ) of >4; and
d) wherein melt index is measured at 190° C. under 2.16 kg force.

2. The compounded polymer of claim 1, wherein the compounded polymer is mixed using specific mechanical energy greater than 0.15 kW/kg/hr at a temperature over 125° C.

3. The compounded polymer of claim 2, wherein the compounded polymer is mixed using a twin-screw compounding extruder at a temperature of 125-299° C.

4. The compounded polymer of claim 1, wherein the virgin HDPE has a melt index of about 6-18 g/10 min, and the PCR HDPE has a melt index of about 0.5 to 0.9 g/10 min.

5. The compounded polymer of claim 1, wherein the compounded polymer has a M_{w}/Mₙ>5.

6. The compounded polymer of claim 1, wherein the virgin HDPE and the PCR HPDE each have a density of 0.930-0.970 g/cm³ and the compounded polymer has a density of about 0.96 g/cm³.

7. The compounded polymer of claim 1, wherein the ratio of virgin HPDE to PCR HPDE is about 50/50.

8. The compounded polymer of claim 1, wherein the ratio of virgin HPDE to PCR HPDE is about 47/53.

9. The compounded polymer of claim 1, wherein the virgin HPDE and the PCR HPDE are food safe.

10. The compounded polymer of claim 2, said compounded polymer comprising:
a) 50-80 weight % of a virgin HDPE having a melt index of about 8 g/10 min;
b) 20-50 weight % of a PCR HDPE having a melt index of about 0.5-0.85 g/10 min; and
c) wherein said compounded polymer has a melt index of about 2 g/10 min and a density of about 0.950-0.960 g/cm³ and an M_{w}/Mₙ>5.

11. The compounded polymer of claim 2, said compounded polymer comprising:
a) 45-55 weight % of a virgin HDPE having a melt index of about 8 g/10 min;
b) 45-55 weight % of a PCR HDPE having a melt index of about 0.5-0.9 g/10 min; and
c) wherein said compounded polymer is food safe and has a melt index of about 2 and a density of about 0.950-0.960 g/cm³ and an M_{w}/Mₙ>5.

12. A polymeric film, said film comprising the compounded polymer of claim 3, wherein said film has 90% fewer gels than a similar polymer compounded with a single screw extruder.

13. The film of claim 12, wherein said film has a defect count less than 133 defects per meter² for a defect size between 500 mm and 7500 mm.

14. The film of claim 12, wherein said film has a defect count less than 15 defects per meter² for a defect size between 750 mm and 1000 mm.

15. The film of claim 12, wherein said film has a defect count less than 1.5 defects per meter² for a defect size between 1000 mm and 1250 mm.

16. The film in claim 12, wherein said film has a defect count less than 1.5 defects per meter² for a defect size of at least 1250 mm.

17. A multilayer film comprising one or more layers of the compounded polymer of claim 3 and one or more layers of a virgin polymer, said multilayer film having a moisture vapor transmission rate (MVTR) of less than 0.28 g/100 inch²/day when measured at 1.5 mil, 37.8° C. and 90% humidity.

18. The film of claim 17, wherein the MVTR is less than 0.12 g/100 inch²/day.

19. The film of claim 17, wherein the MVTR is less than 0.08 g/100 inch²/day.

20. The film of claim 17, wherein said film has a defect count less than 1.5 defects per meter² for a defect size of greater than or equal to 1500 mm.
